(19) United States
(12) Patent Application Publication
(10) Pub. No.: US 2024/0377308 A1
(43) Pub. Date: Nov. 14, 2024

(54) AREA IDENTIFICATION SYSTEM, AREA IDENTIFICATION METHOD, AND RECORDING MEDIUM STORING AREA IDENTIFICATION PROGRAM

(71) Applicant: NEC Corporation, Minato-ku, Tokyo (JP)

(72) Inventor: Takahiro ONO, Tokyo (JP)

(73) Assignee: NEC Corporation, Minato-ku, Tokyo (JP)

(21) Appl. No.: 18/690,327

(22) PCT Filed: Sep. 24, 2021
(86) PCT No.: PCT/JP2021/034947

§ 371 Date: Mar. 8, 2024

(51) Int. Cl. G01N 15/06; B65G 3/02; G01S 17/89

(52) U.S. Cl. CPC G01N 15/06; B65G 3/02; G01S 17/89

(57) ABSTRACT

In order to identify areas where countermeasures against dust emissions are needed, this area identification system comprises: an acquisition means for acquiring, on the basis of the reflected light of the laser beam that irradiates each position in a target space containing a dust-generating object, positional information corresponding to each position and intensity information corresponding to the intensity of the reflected light reflected at the position corresponding to the positional information; and an identification means for identifying, on the basis of the positional information and the intensity information, an area to be sprayed with a suppressant for suppressing the generation of dust within the target space.

### TECHNICAL FIELD

The present invention relates to, for example, an area identification system and the like being capable of identifying an area for which a countermeasure needs to be taken against dust emission.

### BACKGROUND ART

In various sites in a steel plant or the like, dust is generated mainly from raw materials. Thus, in order to suppress an influence on a surrounding area, it is necessary to take countermeasures such as spraying water or a dust-emission preventing agent over a dust-emitting site where dust is being generated.

For example, PTL 1 discloses a technique of monitoring dust emission by using a laser radar.

### CITATION LIST

### Patent Literature

PTL 1: Japanese Unexamined Patent Application Publication No. 2001-337029

### SUMMARY OF INVENTION

### Technical Problem

However, a location where raw materials are stored, such as a steel plant, takes a large space and thus includes a plurality of dust-emitting sites. In order to take appropriate countermeasures for the plurality of dust-emitting sites, it is necessary to identify an area for which a countermeasure needs to be taken, however, there is no means for identifying such an area.

An object of the present invention is to provide an area identification system and the like being capable of identifying an area for which a countermeasure needs to be taken against dust emission.

### Solution to Problem

The present invention provides an area identification system including:
an acquisition means for acquiring, based on reflected light of laser light emitted to each position within a target space containing a dust-generating object, positional information relating to each of the positions and intensity information relating to intensity of the reflected light reflected at each position according to each piece of the positional information; and
an identification means for identifying, based on the positional information and the intensity information, an area to which a suppressant for suppressing generation of the dust is to be sprayed within the target space.

The present invention provides an identification method including:
acquiring, based on reflected light of laser light emitted to each position within a target space containing a dust-generating object, positional information relating to each of the positions and intensity information relating to intensity of the reflected light reflected at each position according to each piece of the positional information; and
identifying, based on the positional information and the intensity information, an area to which a suppressant for suppressing generation of the dust is to be sprayed on a surface of the object.

The present invention provides a program causing an information processing device to execute:
processing of acquiring, based on reflected light of laser light emitted to each position within a target space containing a dust-generating object, positional information relating to each of the positions and intensity information relating to intensity of the reflected light reflected at each position according to each piece of the positional information; and
processing of identifying, based on the positional information and the intensity information, an area to which a suppressant for suppressing generation of the dust is to be sprayed on a surface of the object.

### Advantageous Effects of Invention

The present invention is able to provide an area identification system and the like being capable of identifying an area for which a countermeasure needs to be taken against dust emission.

### BRIEF DESCRIPTION OF DRAWINGS

FIG. 1 is a block diagram illustrating a configuration example of an area identification system according to a first example embodiment of the present invention.

FIG. 2 is a diagram for describing details of the area identification system according to the first example embodiment of the present invention.

FIG. 3 is a diagram for describing details of the area identification system according to the first example embodiment of the present invention.

FIG. 4 is a diagram for describing details of the area identification system according to the first example embodiment of the present invention.

FIG. 5 is a flowchart illustrating an operation example of the area identification system according to the first example embodiment of the present invention.

FIG. 6 is a flowchart illustrating a modification example of the area identification system according to the first example embodiment of the present invention.

FIG. 7 is a block diagram illustrating a configuration example of an area identification system according to a second example embodiment of the present invention.

FIG. 8 is a flowchart illustrating an operation example of the area identification system according to the second example embodiment of the present invention.

FIG. 9 is a block diagram illustrating a configuration example of an area identification system according to a third example embodiment of the present invention.

FIG. 10 is a flowchart illustrating an operation example of the area identification system according to the third example embodiment of the present invention.

FIG. 11 is a block diagram illustrating a configuration example of an area identification system according to a fourth example embodiment of the present invention.

FIG. 12 is a flowchart illustrating an operation example of the area identification system according to the fourth example embodiment of the present invention.

FIG. 13 is a diagram illustrating one example of an information processing device that implements, for example, the area identification systems according to the first, second, third, and fourth example embodiments of the present invention.

### EXAMPLE EMBODIMENT

### First Example Embodiment

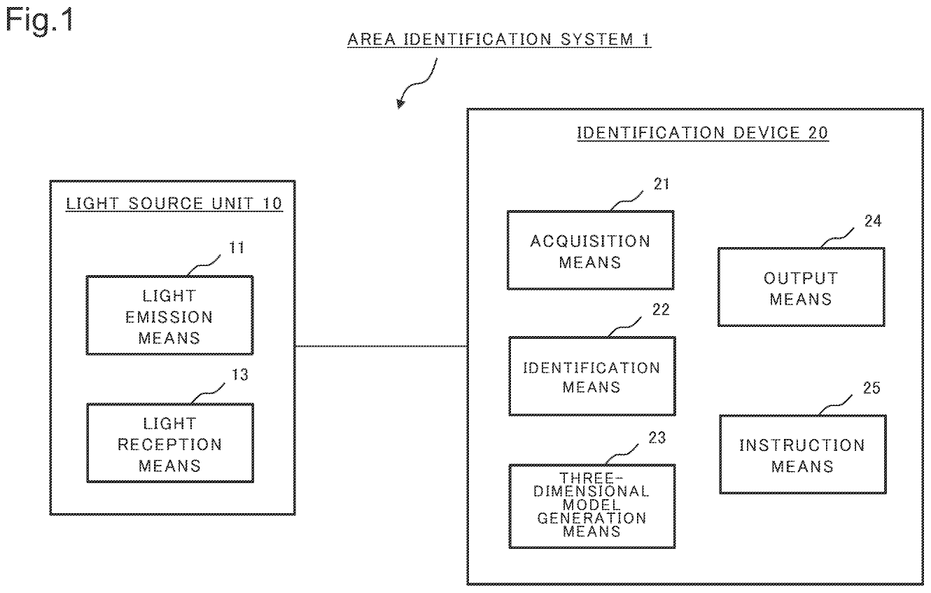

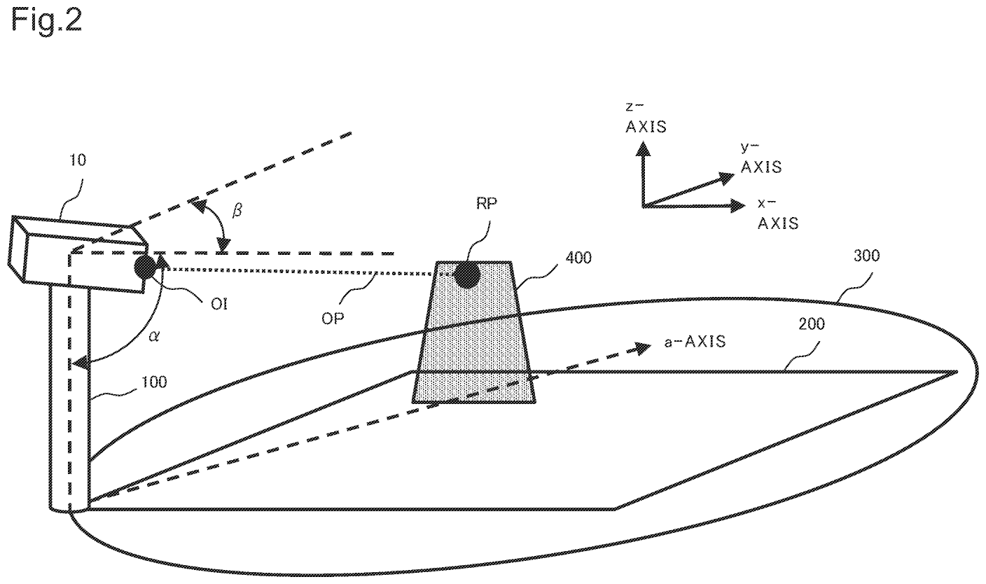

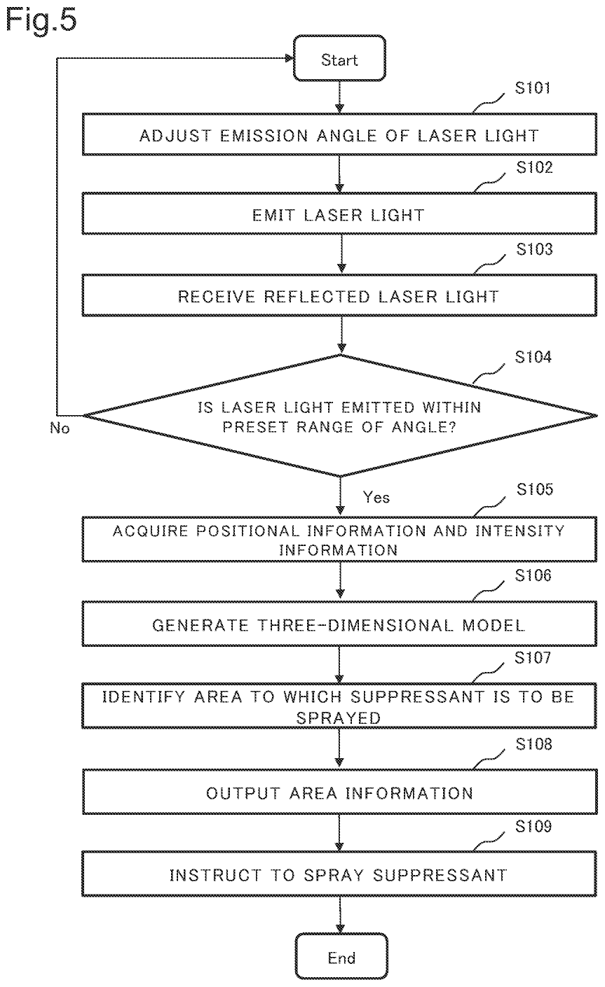

An area identification system 1 according to a first example embodiment is described with reference to FIGS. 1, 2, 3, 4, and 5. FIG. 1 is a block diagram illustrating a configuration example of the area identification system 1. FIGS. 2, 3, and 4 are diagrams for describing details of the area identification system 1. FIG. 5 is a flowchart illustrating an operation example of the area identification system 1.

The configuration of the area identification system 1 is described. The area identification system 1 includes a light source unit 10 and an identification device 20. Although the light source unit 10 and the identification device 20 are provided separately in FIG. 1, these two may be configured as a single body. The light source unit 10 and the identification device 20 are communicable with each other wirelessly or via a wired link.

Referring to FIG. 1, the light source unit 10 includes a light emission means 11 and a light reception means 13.

The light emission means 11 emits laser light to an area 300 to be emitted with light including a target space 200. Specifically, the laser light is pulsed laser light. As illustrated in FIGS. 2, 3, and 4, for example, the light emission means 11 emits laser light from an optical input-output terminal OI provided on the light source unit 10. The emitted laser light propagates along an optical path OP and is incident on a reflection point RP on an object present within the target space 200. The optical path OP is a line segment connecting the optical input-output terminal OI and the reflection point RP. The target space is a space containing a dust-generating object. For example, the target space is a space containing a raw material yard within which raw materials such as coal and iron ores are placed. The object is a raw material or a stack of raw materials placed within the raw material yard.

The light reception means 13 receives laser light reflected by a raw material 400 within the target space 200 (hereinafter referred to as “reflected laser light”). In the example of FIGS. 2, 3, and 4, for example, the light reception means 13 receives the reflected laser light from the reflection point RP on the raw material 400 via the optical path OP and the optical input-output terminal OI. Meanwhile, the light source unit 10 may change, as described hereinafter, the direction in which laser light is emitted, in such a way that the light reception means 13 is able to receive reflected laser light from a different reflection point RP.

Next, the identification device 20 is described. Referring to FIG. 1, the identification device 20 includes an acquisition means 21, an identification means 22, a three-dimensional model generation means 23, an output means 24, and an instruction means 25.

Descriptions are given of the acquisition means 21. Based on reflected laser light, the acquisition means 21 acquires positional information relating to each position to which laser light was emitted. Further, based on the reflected laser light, the acquisition means 21 acquires intensity information relating to the intensity of laser light reflected at each of the positions to which the laser light was emitted. Herein, the reflected laser light refers to reflected light of laser light emitted to each position within the target space 200 containing a dust-generating object (raw material 400).

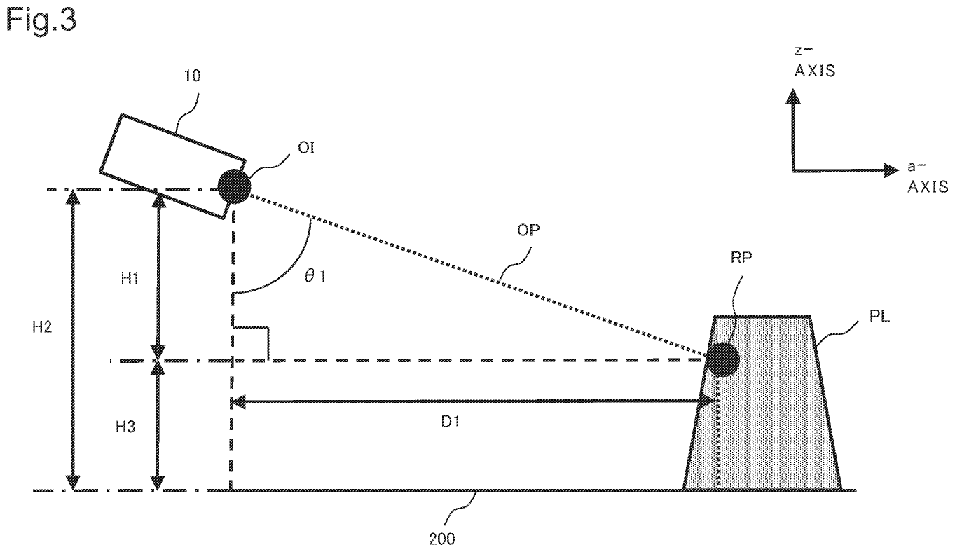

Next, the positional information is described with reference to FIGS. 2, 3, and 4. FIG. 2 illustrates the positional relationship between the light source unit 10 and the target space 200 by using an x-axis, a y-axis, and a z-axis. FIG. 3 illustrates the positional relationship between the light source unit 10 and the target space 200 by using the z-axis and an a-axis. The a-axis is acquired by orthographically projecting the optical path OP onto an x-y plane.

When the light source unit 10 is inclined in an a direction (up-down direction relative to the x-y plane) illustrated in FIG. 2, the light emission means 11 may emit laser light at any angle θ1 as illustrated in FIG. 3. As illustrated in FIG. 3, for example, the angle θ1 is formed by the optical path OP and a straight line extending vertically downward from the optical input-output terminal OI for laser light. The acquisition means 21 may detect the angle θ1 with, for example, a gyro sensor (not illustrated).

The acquisition means 21 determines the length of the optical path OP by using a time period (hereinafter referred to as the time period t) from a time at which the light emission means 11 emits laser light to a time at which the light reception means 13 receives reflected laser light. Specifically, the length of the optical path OP is determined by multiplying the time period t by the light velocity and then dividing the result by two. The acquisition means 21 is able to calculate the difference (H1 in FIG. 3) between the z coordinate of the optical input-output terminal OI for laser light and the z coordinate of the reflection point RP for the laser light by multiplying the length of the optical path OP by cos θ1. In such a way, the acquisition means 21 acquires, on the z-axis, the relative position of the reflection point RP relative to the optical input-output terminal OI.

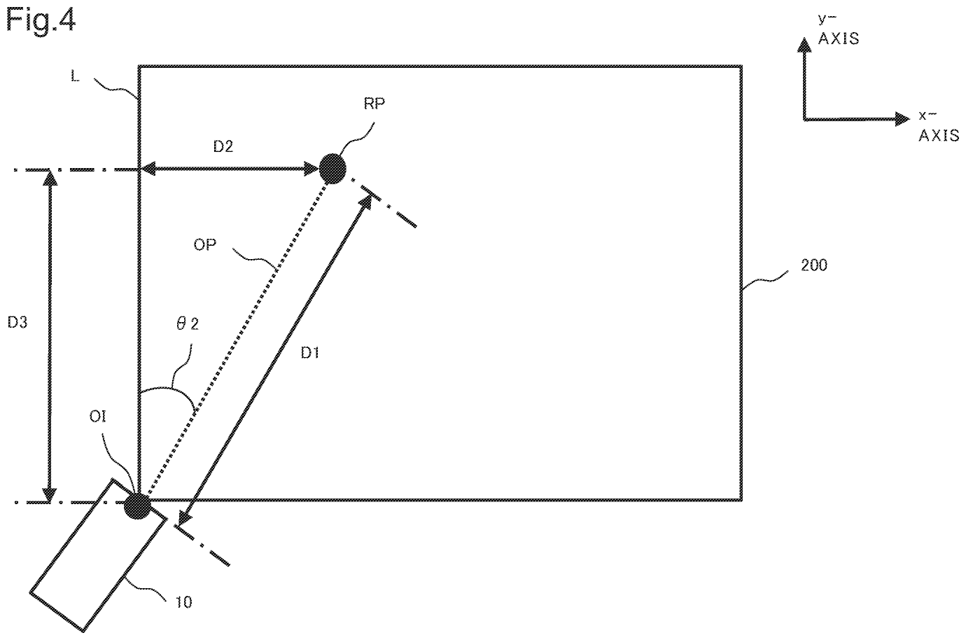

In addition, the acquisition means 21 calculates the length of a line segment D1 of the optical path OP projected onto the x-y plane by multiplying the length of the optical path OP by sin θ1. As illustrated in FIG. 4, the line segment D1 is a line connecting, on the x-y plane, the optical input-output terminal OI and the reflection point RP for laser light.

When the light source unit 10 is inclined in a β direction (direction parallel to the x-y plane) illustrated in FIG. 2, the light emission means 11 may emit laser light at any angle θ2. As illustrated in FIG. 4, for example, the angle θ2 is formed by the optical path OP and a reference line L set on the x-y plane. In the example illustrated in FIG. 4, the reference line L is one of the sides forming the perimeter of the target space 200. The acquisition means 21 may detect the angle θ2 with, for example, a gyro sensor (not illustrated).

The acquisition means 21 determines the difference (D2 in FIG. 4) between the x coordinate of the optical input-output terminal OI and the x coordinate of the reflection point RP by multiplying the length of the line segment D1 by sin θ2. Further, the acquisition means 21 determines the difference (D3 in FIG. 4) between the y coordinate of the optical input-output terminal OI and the y coordinate of the reflection point RP by multiplying the length of the line segment D1 by cos θ2. In such a way, the acquisition means 21 acquires, on each of the x-axis and the y-axis, the relative position of the reflection point RP relative to the optical input-output terminal OI. The acquisition means 21 stores the acquired relative position on each of the axes in association with the angles θ1 and 02.

The light source unit 10 changes at least one of the angles θ1 and 02 in such a way as to cause laser light to be incident on a reflection point RP at a different position. The light source unit 10 emits laser light in accordance with a plurality of angles θ1 and a plurality of angles θ2 that are preset, and thus receives reflected laser light from a plurality of reflection points RP within the light-emitted area 300. In such a way, the acquisition means 21 may acquire a relative position on each of the axes for each of the plurality of reflection points RP within the target space 200 acquisition. The acquisition means 21 acquires the relative position, which is acquired on each of the axes as described above for each of the reflection points RP, as positional information. The acquisition means 21 may convert the relative position into an absolute position with reference to a prescribed reference point in such a way as to acquire positional information.

Upon receipt of reflected light from a reflection point RP, the light reception means 13 reports the intensity of the reflected light to the acquisition means 21. Thus, the acquisition means 21 may acquire, for each reflection point RP, intensity information relating to the intensity of reflected laser light. The acquisition means 21 outputs the acquired positional information and intensity information to the identification means 22.

The identification means 22 identifies, based on the positional information and the intensity information, an area to which a suppressant for suppressing the generation of dust is to be sprayed within the target space 200.

For example, the identification means 22 identifies, as an area to which the suppressant is to be sprayed, a set of positions from which reflected light having an intensity equal to or greater than a threshold has been reflected, from among positions according to the positional information. As a general rule, when a suppressant for suppressing the generation of dust has already been sprayed to a raw material, the raw material is in a wet state or a state in which a liquid agent is solidified. Thus, light reflected within a spraying-completed area has more specular reflection components and few backscattering components. As a result, the intensity of reflected light from an area to which the suppressant has already been sprayed is low. Accordingly, the identification means 22 may identify that the set of positions from which reflected light having an intensity equal to or greater than the threshold has been reflected is an area to which the suppressant has not been sprayed.

According to the description above, light reflected within a spraying-completed area has more specular reflection components and few backscattering components. Meanwhile, depending on the type of a suppressant or the type of a raw material, light reflected within a spraying-completed area may have more backscattering components. In such a case, the identification means 22 identifies that a set of positions from which reflected light having an intensity less than the threshold has been reflected, from among positions according to the positional information, is an area to which the suppressant has not been sprayed.

Note that, the threshold may be the same for all the reflection points RP from which laser light has been reflected, or may differ according to the reflection points RP. For example, the threshold is set based on the distance from a reflection point RP to the optical input-output terminal OI. Specifically, when the threshold differs according to reflection points RP, a lower threshold may be set for longer optical paths OP each extending from the optical input-output terminal OI to a reflection point RP.

The three-dimensional model generation means 23 may generate a three-dimensional model of the target space 200 by using positional information. The three-dimensional model is an aggregate of points of which the position is uniquely defined by a coordinate on the x-axis, a coordinate on the y-axis, and a coordinate on the z-axis. The three-dimensional model is, for example, a three-dimensional point group model. Based on relative positions acquired by the acquisition means 21 for reflection points RP relative to the optical input-output terminal O1, the three-dimensional model generation means 23 plots a plurality of reflection points RP in the three-dimensional model in such a way as to generate a model indicative of the shape of an object within the target space 200. When identifying an area to which a suppressant has not been sprayed, the identification means 22 may identify an area in the three-dimensional model.

The output means 24 outputs area information indicating an area identified by the identification means 22. Specifically, the output means 24 outputs, as area information, positional information relating to an area identified by the identification means 22 to external devices such as a display, a speaker, and other information processing devices.

The instruction means 25 instructs a spraying means (not illustrated) capable of spraying a suppressant to spray the suppressant to an area identified by the identification means 22. The spraying means is, for example, a sprinkler storing a suppressant. The identification means 22 outputs, to the instruction means 25, positional information relating to a position that has been identified as an area to which the suppressant has not been sprayed. The instruction means 25 reports the positional information from the identification means 22 to the spraying means, and the spraying means sprays the suppressant to the area to which the suppressant has not been sprayed.

Next, an operation example of the area identification system 1 is described with reference to FIG. 5.

The light source unit 10 adjusts the emission angle of laser light (S101). For example, the light source unit 10 adjusts the angle θ1 illustrated in FIG. 3 and the angle θ2 illustrated in FIG. 4 to a prescribed angle.

The light emission means 11 of the light source unit 10 emits laser light (S102). As a result, the laser light is reflected at a reflection point RP on the raw material 400.

The light reception means 13 of the light source unit 10 receives reflected laser light (S103). In such a case, a time period t from the time at which the laser light is emitted to the time at which the reflected laser light is received is stored in a memory (not illustrated) of the identification device 20 in association with the emission angle of the laser light. In such a case, the light source unit 10 stores the intensity of reflected laser light in addition to the time period t.

The light source unit 10 determines whether the laser light was emitted within a preset range of angle (S104).

If the laser light was not emitted within the preset range of angle (No in S104), the light source unit 10 adjusts the emission angle of laser light (S101). For example, the light source unit 10 changes at least one of the angle θ1 illustrated in FIG. 3 or the angle θ2 illustrated in FIG. 4.

If the laser light was emitted within the preset range of angle (Yes in S104), the acquisition means 21 acquires, based on the reflected laser light, positional information relating to each position to which the laser light was emitted and intensity information relating to the intensity of the reflected laser light reflected at each position to which the laser light was emitted (S105).

The three-dimensional model generation means 23 generates a three-dimensional model of the target space 200 by using the positional information (S106). The identification means 22 identifies, based on the positional information and the intensity information, an area to which a suppressant for suppressing the generation of dust is to be sprayed within the target space 200 (S107). In the processing of S108, the identification means 22 identifies, in the three-dimensional model, an area to which the suppressant is to be sprayed.

The output means 24 outputs area information indicating the area identified by the identification means 22 (S108). The instruction means 25 instructs a spraying means (not illustrated) to spray the suppressant to the area identified by the identification means 22 (S109). Note that the processing of S108 and S109 may be performed in parallel.

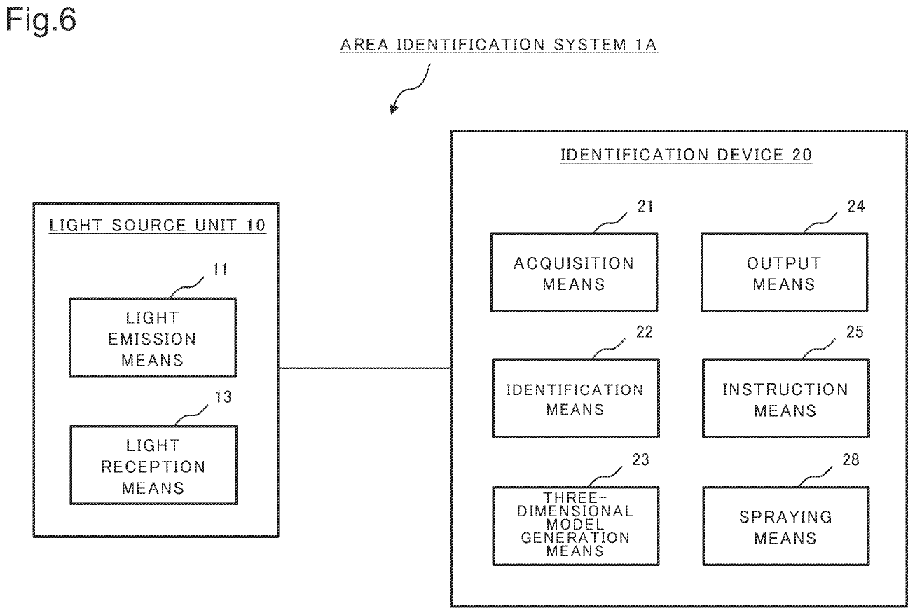

Next, an area identification system 1A is described with reference to FIG. 6. The area identification system 1A is a modification example of the area identification system 1. In FIG. 1, the area identification system 1 does not include the spraying means described above. The area identification system 1A differs from the area identification system 1 in that, as illustrated in FIG. 6, the same includes a spraying means 28.

The area identification system 1 has been described above. In the area identification system 1, the acquisition means 21 acquires positional information relating to each position to which laser light was emitted and intensity information relating to the intensity of reflected laser light reflected at each of the positions to which the laser light was emitted. The identification means 22 identifies, based on the positional information and the intensity information, an area to which a suppressant for suppressing the generation of dust is to be sprayed within the target space. As described above, the area identification system 1 may identify an area for which a countermeasure needs to be taken against dust emission. Accordingly, the suppressant can be suitably sprayed to the area for which a countermeasure needs to be taken against dust emission, and the area for which a countermeasure needs to be taken against dust emission may be reported to a user.

### Second Example Embodiment

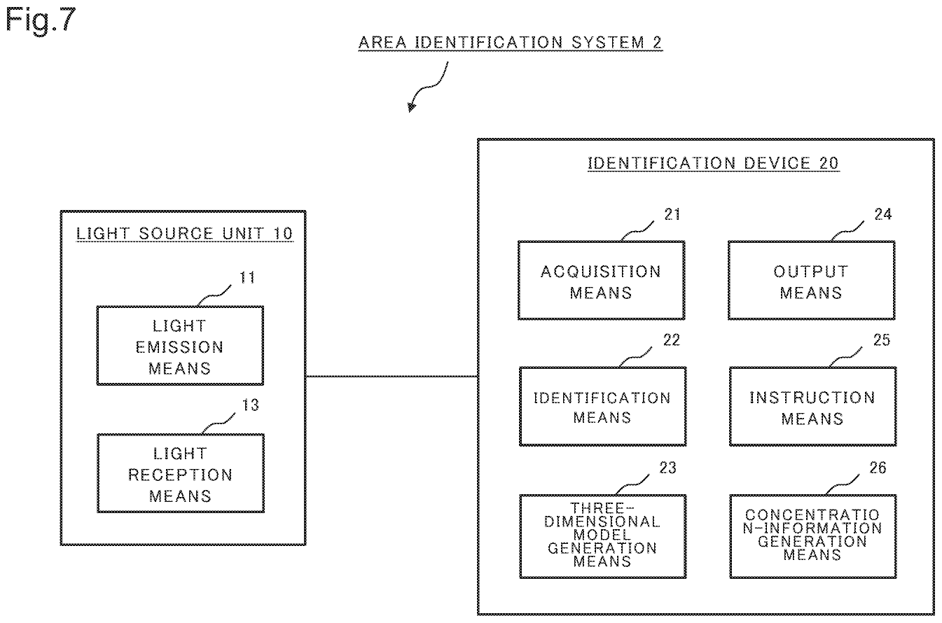

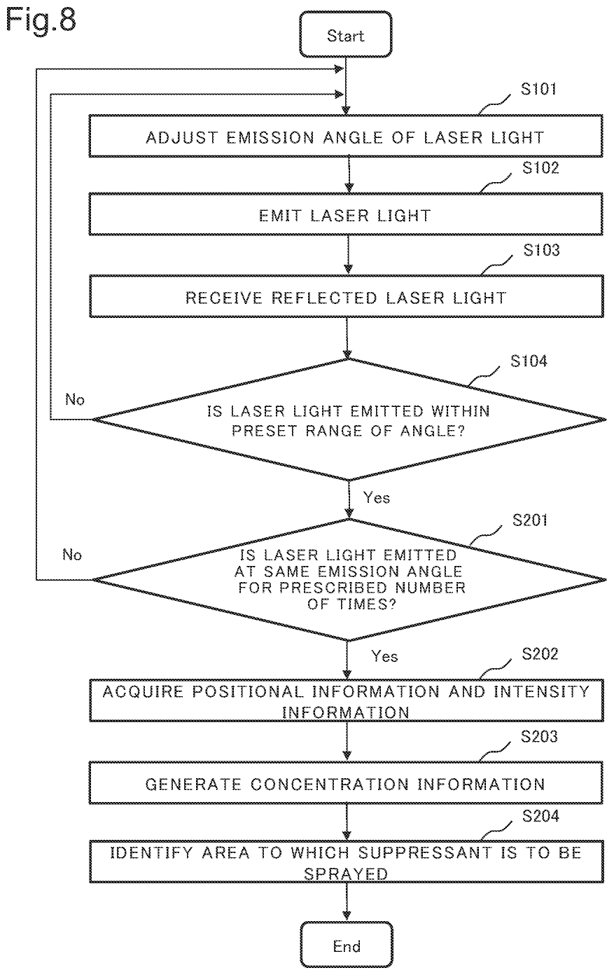

An area identification system 2 according to a second example embodiment is described with reference to FIGS. 7 and 8. FIG. 7 is a block diagram illustrating a configuration example of the area identification system 2. FIG. 8 is a flowchart illustrating an operation example of the area identification system 2. In FIG. 7, an element equivalent to each element illustrated in FIGS. 1 to 4 are assigned with a sign equivalent to those illustrated in FIGS. 1 to 4.

The configuration of the area identification system 2 is described. The area identification system 2 includes a light source unit 10 and an identification device 20. The light source unit 10 includes a light emission means 11 and a light reception means 13. The identification device 20 includes an acquisition means 21, an identification means 22, a three-dimensional model generation means 23, an output means 24, an instruction means 25, and a concentration-information generation means 26. The area identification system 2 differs from the area identification system 1 in that the area identification system 2 further includes the concentration-information generation means 26.

The concentration-information generation means 26 generates, based on the intensity of reflected light, concentration information relating to the concentration of dust within a target space. In the area identification system 2, specifically, the light emission means 11 emits laser light a plurality of times at the same angles θ1 and θ2. The light reception means 13 receives reflected light of the laser light a plurality of times, and outputs intensity information to the acquisition means 21 every time the reflected light is received. Thus, the acquisition means 21 may acquire the intensity of the laser light from the same position a plurality of times. The acquisition means 21 acquires intensity information a plurality of times and outputs the same to the concentration-information generation means 26.

The concentration-information generation means 26 adds up, for each position, intensity indicated by intensity information acquired a plurality of times. The concentration-information generation means 26 acquires an average value by dividing the result of adding up by the number of times the intensity information has been acquired. In addition, based on the calculated average value, the concentration-information generation means 26 generates concentration information relating to the concentration of dust within the target space 200. For example, as the average value at each position becomes higher, the concentration-information generation means 26 generates concentration information indicating that the concentration of dust at the position is higher. Meanwhile, as the average value at each position becomes lower, the concentration-information generation means 26 generates concentration information indicating that the concentration of dust at the position is lower. As described above, the concentration-information generation means 26 generates concentration information, based on the average value acquired by dividing the sum of intensity indicated by intensity information acquired a plurality of times by the number of times the intensity information has been acquired.

The identification means 22 identifies, based on concentration information indicating the concentration of dust for each position, an area to which a suppressant for suppressing the generation of dust is to be sprayed within the target space 200. For example, the identification means 22 identifies, as an area to which the suppressant is to be sprayed, a set of positions having a concentration equal to or greater than a prescribed threshold, from among positions within the target space 200.

According to the description above, the area identification system 1 identifies an area to which the suppressant is to be sprayed, based on intensity information generated from the intensity of reflected light acquired once. The area identification system 2 may also use the above-described method of the area identification system 1. In the area identification system 2, the user can appropriately switch between the method of the area identification system 1 and the method of the area identification system 2 for use. In the area identification system 2, the identification means 22 may identify, as an area to which the suppressant is to be sprayed anew, a position that has been identified as an area to which the suppressant is to be sprayed, by using both of the two methods. Alternatively, the identification means 22 may identify, as an area to which the suppressant is to be sprayed anew, a position that has been identified as an area to which the suppressant is to be sprayed, by using one of the two techniques.

Next, an operation example of the area identification system 2 is described with reference to FIG. 8. The area identification system 2 performs the processing of S101 to S105 of the area identification system 1. Then, the light emission means 11 determines whether laser light has been emitted at the same emission angle a prescribed number of times (S201). When the laser light has not been emitted at the same angle a prescribed number of times (No in S201), the light source unit 10 adjusts the emission angle of laser light (S101).

When the laser light has been emitted at the same emission angle a prescribed number of times (No in S201), the acquisition means 21 acquires positional information and intensity information (S202). In the processing of S202, the acquisition means 21 acquires, as intensity information, the intensity of reflected light reflected from the same position a plurality of times.

The concentration-information generation means 26 generates concentration information, based on positional information and intensity information (S203). Specifically, the concentration-information generation means 26 generates concentration information, based on the average value acquired by dividing the sum of intensity indicated by intensity information acquired a plurality of times by the number of times the intensity information has been acquired.

Based on the concentration information, the identification means 22 identifies an area to which the suppressant is to be sprayed. For example, the identification means 22 identifies, as an area to which the suppressant is to be sprayed, a set of positions having a concentration equal to or greater than a prescribed threshold, from among positions within the target space 200.

Although not illustrated in FIG. 7, the area identification system 2 may perform in parallel the processing of S106 to S109, which are specific to the area identification system 1, after performing the processing of S105.

Similarly to the area identification system 1A illustrated in FIG. 6, the area identification system 2 may further include a spraying means 28.

Descriptions have been given of the area identification system 2. The area identification system 2 has a similar configuration to the area identification system 1, and thus may identify an area for which a countermeasure needs to be taken against dust emission, as with the area identification system 1. Accordingly, the suppressant can be suitably sprayed to an area for which a countermeasure needs to be taken against dust emission, and the area for which a countermeasure needs to be taken against dust emission may be reported to a user.

The area identification system 2 further includes a concentration-information generation means. Thus, a position with a high concentration of dust within the target space 200 may be identified as an area for which a countermeasure needs to be taken against dust emission. Accordingly, the suppressant may be suitably sprayed to an area with a high concentration of dust, and the area with a high concentration of dust may be reported to a user.

### Third Example Embodiment

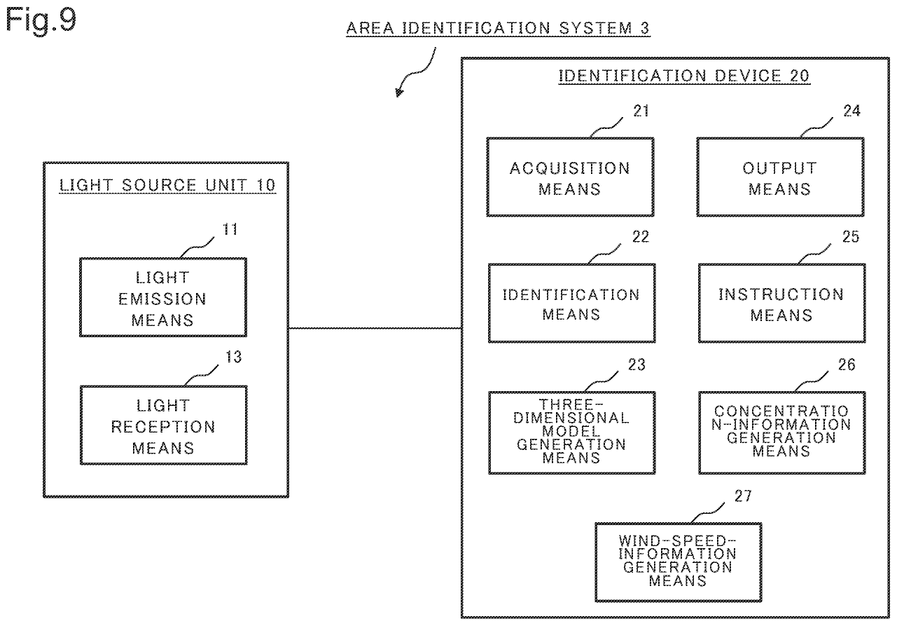

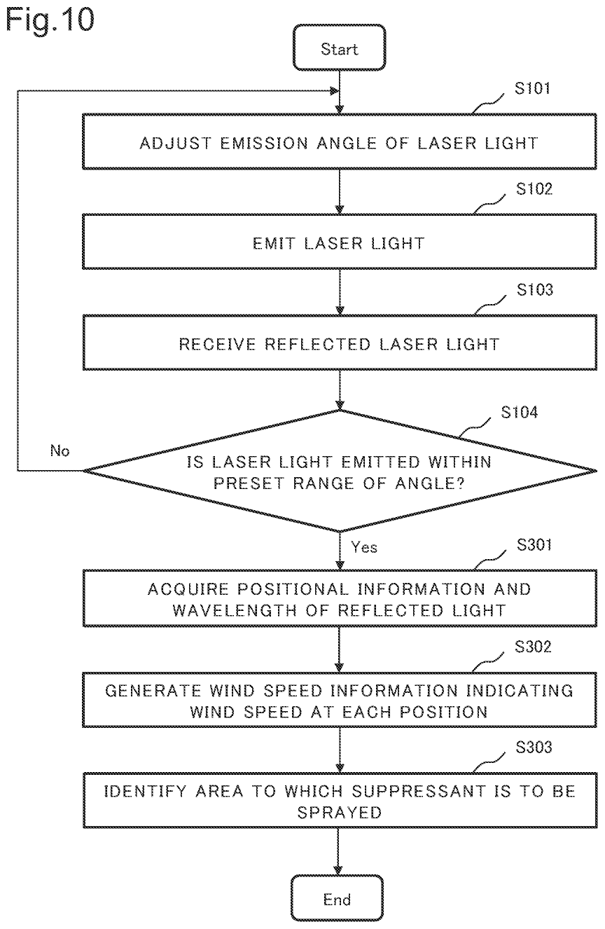

An area identification system 3 according to a third example embodiment is described with reference to FIGS. 9 and 10. FIG. 9 is a block diagram illustrating a configuration example of the area identification system 3. FIG. 10 is a flowchart illustrating an operation example of the area identification system 3. In FIG. 9, an element equivalent to each element illustrated in FIGS. 1 to 4 and 7 are assigned with a sign equivalent to the signs illustrated in FIGS. 1 to 4 and 7.

The configuration of the area identification system 3 is described. The area identification system 3 includes a light source unit 10 and an identification device 20. The light source unit 10 includes a light emission means 11 and a light reception means 13. The identification device 20 includes an acquisition means 21, an identification means 22, a three-dimensional model generation means 23, an output means 24, an instruction means 25, a concentration-information generation means 26, and a wind-speed-information generation means 27. The area identification system 3 differs from the area identification system 2 in that the area identification system 3 further includes the wind-speed-information generation means 27.

The wind-speed-information generation means 27 calculates the travel speed of dust, based on the difference in frequency between laser light and reflected laser light and determines the wind speed of wind within a target space, based on the travel speed. The wind-speed-information generation means 27 stores, in advance, the frequency of laser light emitted by the light emission means 11. The light reception means 13 performs coherent detection of reflected laser light by using local oscillator light having the same frequency as laser light, to thereby detect the frequency of the reflected laser light. The wind-speed-information generation means 27 calculates the difference between the frequency of the laser light and the frequency of the reflected laser light as a frequency shift amount resulting from the Doppler effect. Furthermore, it is assumed that the wind-speed-information generation means 27 determines the travel speed of dust from the frequency shift amount and defines such travel speed as a wind speed at the position of a reflection point RP. The wind-speed-information generation means 27 generates, as wind speed information, information indicating the wind speed at each of the positions of reflection points RP.

In the area identification system 3, the identification means 22 identifies, based on wind speed information indicating the wind speed at each position within the target space 200, an area to which a suppressant for suppressing the generation of dust is to be sprayed within the target space 200. As a general rule, as the wind speed increases, dust emission occurs more easily. Thus, for example, the identification means 22 identifies, as an area to which the suppressant is to be sprayed, a set of positions having a wind speed equal to or greater than a prescribed threshold, from among positions within the target space 200. The identification means 22 may also identify, as an area to which the suppressant is to be sprayed, positions having a wind speed equal to or greater than a prescribed threshold and the vicinity thereof.

Next, an operation example of the area identification system 3 is described with reference to FIG. 10. The area identification system 3 performs the processing of S101 to S104 of the area identification system 1. Then, the acquisition means 21 acquires positional information relating to reflection points RP and the wavelength of reflected light of laser light from the light source unit 10.

The wind-speed-information generation means 27 generates, as wind speed information, information indicating the wind speed at each of the positions of reflection points RP (S302). Based on the wind speed information, the identification means 22 identifies an area to which the suppressant is to be sprayed (S303).

Although not illustrated in FIG. 10, the area identification system 3 may perform in parallel the processing of S105 to S109, which are specific to the area identification system 1, and the processing of S201 to S204, which are specific to the area identification system 2, after performing the processing of S104.

Similarly to the area identification system 1A illustrated in FIG. 6, the area identification system 3 may further include a spraying means 28.

Descriptions have been given of the area identification system 3. The area identification system 3 has a similar configuration to the area identification system 1, and thus can identify an area for which a countermeasure needs to be taken against dust emission, as with the area identification system 1. Accordingly, the suppressant can be suitably sprayed to an area for which a countermeasure needs to be taken against dust emission, and the area for which a countermeasure needs to be taken against dust emission can be reported to a user.

As with the area identification system 2, the area identification system 3 further includes a concentration-information generation means. Thus, a position with a high concentration of dust within the target space 200 can be identified as an area for which a countermeasure needs to be taken against dust emission. Accordingly, the suppressant can be suitably sprayed to an area with a high concentration of dust, and the area with a high concentration of dust can be reported to the user.

The area identification system 3 further includes the wind-speed-information generation means 27. Thus, a position with a high wind speed within the target space 200 can be identified as an area for which a countermeasure needs to be taken against dust emission. Accordingly, the suppressant can be suitably sprayed to an area with a high wind speed, and the area with a high wind speed can be reported to the user.

According to the description above, the identification means 22 of the area identification system 1 identifies, based on intensity information generated from the intensity of reflected light acquired once, an area to which the suppressant is to be sprayed. According to the description above, the identification means 22 of the area identification system 2 identifies, based on concentration information, an area to which the suppressant is to be sprayed. The area identification system 3 may also use the above-described methods of the area identification systems 1 and 2. In the area identification system 3, the user can appropriately switch between the method of the area identification system 1, the method of the area identification system 2, and the method of the area identification system 3 for use. In the area identification system 3, the identification means 22 may identify, as an area to which the suppressant is to be sprayed anew, a position that has been identified as an area to which the suppressant is to be sprayed, by using both of the three methods. Alternatively, the identification means 22 may identify, as an area to which the suppressant is to be sprayed anew, a position that has been identified as an area to which the suppressant is to be sprayed, by using one of the three techniques.

### Fourth Example Embodiment

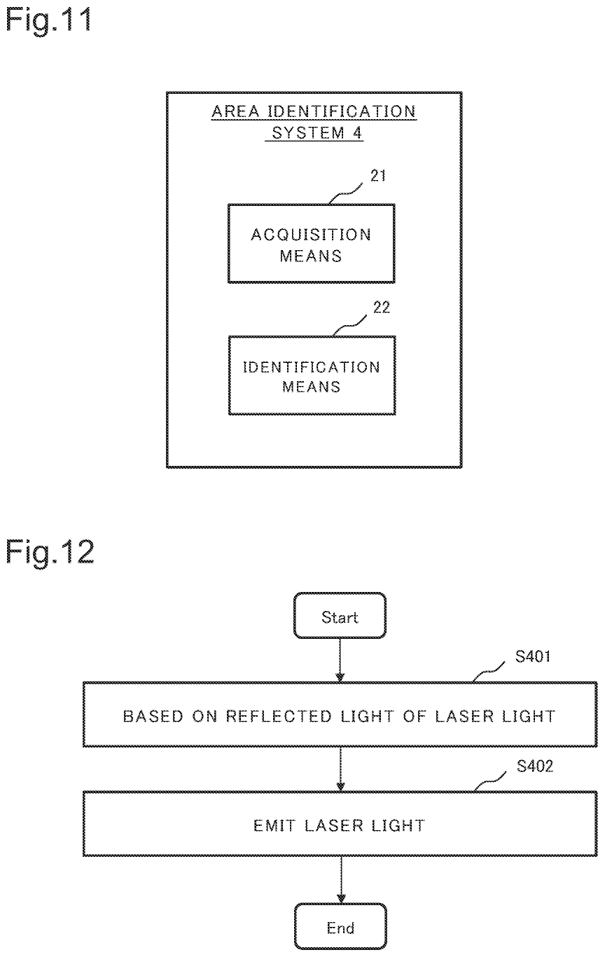

An area identification system 4 according to a fourth example embodiment is described with reference to FIGS. 11 and 12. FIG. 11 is a block diagram illustrating a configuration example of the area identification system 4. FIG. 12 is a flowchart illustrating an operation example of the area identification system 4.

As illustrated in FIG. 11, the area identification system 4 includes an acquisition means 21 and an identification means 22. It is assumed that a light source unit 10 (not illustrated) is provided outside of the area identification system 4 and is able to communicate with the area identification system 4. The acquisition means 21 and the identification means 22 of the area identification system 4 may have similar functions and connection relationships to the acquisition means 21 and the identification means 22 of the area identification systems 1, 2, and 3.

Similarly to the area identification system 1A illustrated in FIG. 6, the area identification system 4 may further include a spraying means 28.

The acquisition means 21 acquires, based on reflected light of laser light emitted to each position within a target space containing a dust-generating object, positional information relating to each of the positions and intensity information relating to the intensity of the reflected light reflected at each of the positions according to each piece of positional information.

The identification means 22 identifies, based on the positional information and the intensity information, an area to which a suppressant for suppressing the generation of dust is to be sprayed within the target space.

Next, an operation example of the area identification system 4 is described with reference to FIG. 12.

The acquisition means 21 acquires, based on reflected light of laser light, positional information relating to each position and intensity information relating to the intensity of the reflected light reflected at each of the positions according to each piece of positional information (S401).

The identification means 22 identifies, based on the positional information and the intensity information, an area to which a suppressant for suppressing the generation of dust is to be sprayed within the target space (S402).

Descriptions have been given of the area identification system 4. In the area identification system 4, the acquisition means 21 acquires positional information relating to each position to which laser light was emitted and intensity information relating to the intensity of reflected laser light reflected at each of the positions to which the laser light was emitted. The identification means 22 identifies, based on the positional information and the intensity information, an area to which a suppressant for suppressing the generation of dust is to be sprayed within the target space. As described above, the area identification system 4 may identify an area for which a countermeasure needs to be taken against dust emission. Accordingly, the suppressant can be suitably sprayed to an area for which a countermeasure needs to be taken against dust emission, and the area for which a countermeasure needs to be taken against dust emission can be reported to a user.

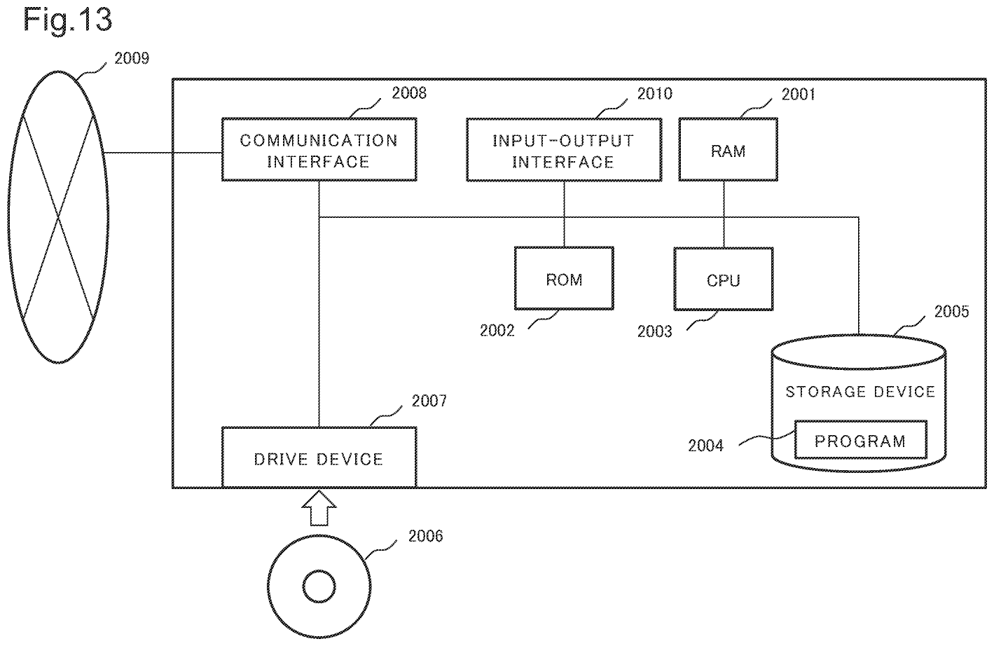

Some or all of the elements of each device or system are implemented using, for example, any combination of a program and an information processing device 2000, as illustrated in FIG. 13. FIG. 13 illustrates an example of an information processing device that implements, for example, the area identification systems 1, 2, 3, and 4. As an example, the information processing device 2000 includes the following components.
Central processing unit (CPU) 2001
Read only memory (ROM) 2002
Random access memory (RAM) 2003
Program 2004 loaded into RAM 2003
Storage device 2005 for storing program 2004
Drive device 2007 for reading/writing from/to recording medium 2006
Communication interface 2008 connected to communication network 2009
Input-output interface 2010 for receiving input of data or outputting data
Bus 2011 for connecting elements

The elements of each device in each example embodiment are implemented by the CPU 2001 acquiring and executing the program 2004, which implements the functions of the elements. The program 2004 that implements the functions of the elements of each device is stored in, for example, the storage device 2005 or the RAM 2003 in advance and read by the CPU 2001 as needed. The program 2004 may be supplied to the CPU 2001 via the communication network 2009, or may be stored in the recording medium 2006 in advance and read and supplied to the CPU 2001 by the drive device 2007.

The method for implementing each device has various modification examples. For example, each device may be implemented using any different combination of an information processing device 2000 and a program for each element. A plurality of elements of each device may be implemented using any combination of one information processing device 2000 and a program.

Some or all of the elements of each device are implemented using general-purpose or dedicated circuits (circuitry) including, for example, a processor, or a combination thereof. These elements may be formed from a single chip or may be formed from a plurality of chips connected via a bus. Some or all of the elements of each device or device may be implemented using a combination of the above-described circuits, etc., and a program.

When some or all of the elements of each device are implemented using a plurality of information processing devices, circuits, etc., the plurality of information processing devices, circuits, etc., may be localized or distributed. For example, the information processing devices, circuits, etc., may be implemented in an arrangement in which the devices or circuits are connected over a communication network, such as a client server system or a cloud computing system.

Some or all of the above-described example embodiments may be described as in the following supplementary notes, but are not limited thereto.

### (Supplementary Note 1)

An area identification system including:
an acquisition means for acquiring, based on reflected light of laser light emitted to each position within a target space containing a dust-generating object, positional information relating to each of the positions and intensity information relating to intensity of the reflected light reflected at each position according to each piece of the positional information; and
an identification means for identifying, based on the positional information and the intensity information, an area to which a suppressant for suppressing generation of the dust is to be sprayed within the target space.

### (Supplementary Note 2)

The area identification system according to claim 1, further including a three-dimensional model generation means for generating a three-dimensional model indicating a shape of the object within the target space by using the positional information.

### (Supplementary Note 3)

The area identification system according to supplementary note 1 or 2, wherein
the identification means identifies, as the area to which the suppressant is to be sprayed, a position from which the reflected light having intensity equal to or greater than a threshold is reflected, from among positions according to the positional information.

### (Supplementary Note 4)

The area identification system according to any one of supplementary notes 1 to 3, further including
a concentration-information generation means for generating, based on intensity of the reflected light, concentration information relating to a concentration of the dust within the target space.

### (Supplementary Note 5)

The area identification system according to supplementary note 4, wherein
the acquisition means acquires the intensity information a plurality of times, and
the concentration-information generation means generates the concentration information, based on an average value acquired by dividing a sum of intensity being indicated by the intensity information acquired a plurality of times, by a number of times the intensity information is acquired.

### (Supplementary Note 6)

The area identification system according to supplementary note 4 or 5, wherein the identification means identifies, based on the concentration information, an area to which a suppressant for suppressing generation of the dust is to be sprayed within the target space.

### (Supplementary Note 7)

The area identification system according to any one of supplementary notes 1 to 6, further including
a wind-speed-information generation means, wherein
the acquisition means acquires wavelength information relating to a difference between a wavelength of the reflected light reflected at each position according to each piece of the positional information and a wavelength of the laser light, and
the wind-speed-information generation means generates wind speed information indicating a wind speed at the position according to the positional information, based on the positional information and the wavelength information.

### (Supplementary Note 8)

The area identification system according to supplementary note 7, wherein the identification means identifies, based on the wind speed information, an area to which a suppressant for suppressing generation of the dust is to be sprayed within the target space.

### (Supplementary Note 9)

The area identification system according to any one of supplementary notes 1 to 8, further including an instruction means for instructing a spraying means for spraying the suppressant to spray the suppressant to the area identified by the identification means.

### (Supplementary Note 10)

The area identification system according to any one of supplementary notes 1 to 9, including an output means for outputting area information indicating the area identified by the identification means.

### (Supplementary Note 11)

The area identification system according to any one of supplementary notes 1 to 10, wherein the target space is a raw material yard, and the object is a raw material placed within the raw material yard.

### (Supplementary Note 12)

An identification method including:
acquiring, based on reflected light of laser light emitted to each position within a target space containing a dust-generating object, positional information relating to each of the positions and intensity information relating to intensity of the reflected light reflected at each position according to each piece of the positional information; and
identifying, based on the positional information and the intensity information, an area to which a suppressant for suppressing the generation of the dust is to be sprayed on the surface of the object.

### (Supplementary Note 13)

A storage medium storing an identification program for causing an information processing device to execute:
processing of acquiring, based on reflected light of laser light emitted to each position within a target space containing a dust-generating object, positional information relating to each of the positions and intensity information relating to intensity of the reflected light reflected at each position according to each piece of the positional information; and
processing of identifying, based on the positional information and the intensity information, an area to which a suppressant for suppressing the generation of the dust is to be sprayed on the surface of the object.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1, 2, 3, 4 Area identification system
10 Light source unit
11 Light emission means
13 Light reception means
20 Identification device
21 Acquisition means
22 Identification means
23 Three-dimensional model generation means
24 Output means
25 Instruction means
26 Concentration-information generation means
27 Wind-speed-information generation means
2001 CPU
2002 ROM
2003 RAM
2004 Program
2005 Storage device
2007 Drive device
2008 Communication interface
2009 Communication network
2010 Input-output interface
2011 Bus for connecting elements

What is claimed is:

1. An area identification system comprising:
at least one memory storing a computer program; and
at least one processor configured to execute the computer program to
acquire, based on reflected light of laser light emitted to each position within a target space containing a dust-generating object, positional information relating to each of the positions and intensity information relating to intensity of the reflected light reflected at each of the position according to each piece of the positional information; and
identify, based on the positional information and the intensity information, an area to which a suppressant for suppressing generation of the dust is to be sprayed within the target space.

2. The area identification system according to claim 1, wherein the processor is configured to execute the computer program to generate a three-dimensional model indicating a shape of the object within the target space by using the positional information.

3. The area identification system according to claim 1, wherein the processor is configured to execute the computer program to
identify, as the area to which the suppressant is to be sprayed, a position from which the reflected light having intensity equal to or greater than a threshold is reflected, from among positions according to the positional information.

4. The area identification system according to claim 1, wherein the processor is configured to execute the computer program to
generate, based on intensity of the reflected light, concentration information relating to a concentration of the dust within the target space.

5. The area identification system according to claim 4, wherein the processor is configured to execute the computer program to,
acquire the intensity information a plurality of times, and
generate the concentration information, based on an average value acquired by dividing a sum of intensity being indicated by the intensity information acquired a plurality of times, by a number of times the intensity information is acquired.

6. The area identification system according to claim 4 or 5, wherein the processor is configured to execute the computer program to identify, based on the concentration information instead of the positional information and the intensity information, an area to which a suppressant for suppressing generation of the dust is to be sprayed within the target space.

7. The area identification system according to claim 1, wherein the processor is configured to execute the computer program to
acquire wavelength information relating to a difference between a wavelength of the reflected light reflected at each position according to each piece of the positional information and a wavelength of the laser light, and
generate wind speed information indicating a wind speed at the position according to the positional information, based on the positional information and the wavelength information.

8. The area identification system according to claim 7, wherein the processor is configured to execute the computer program to identify, based on the wind speed information instead of the positional information and the intensity information, an area to which a suppressant for suppressing generation of the dust is to be sprayed within the target space.

9. The area identification system according to claim 1, wherein the processor is configured to execute the computer program to instruct spraying means for spraying the suppressant to spray the suppressant to the area identified by the identification means.

10. The area identification system according to claim 1, wherein the processor is configured to execute the computer program to output area information indicating the area identified by the identification means.

11. The area identification system according to claim 1,
wherein the target space is a raw material yard, and the object is a raw material placed within the raw material yard.

12. An area identification method comprising:
acquiring, based on reflected light of laser light emitted to each position within a target space containing a dust-generating object, positional information relating to each of the positions and intensity information relating to intensity of the reflected light reflected at each of the position according to each piece of the positional information; and
identifying, based on the positional information and the intensity information, an area to which a suppressant for suppressing generation of the dust is to be sprayed on a surface of the object.

13. A non-transitory computer-readable recording medium storing a area identification program causing an information processing device to execute:
processing of acquiring, based on reflected light of laser light emitted to each position within a target space containing a dust-generating object, positional information relating to each of the positions and intensity information relating to intensity of the reflected light reflected at each of the position according to each piece of the positional information; and
processing of identifying, based on the positional information and the intensity information, an area to which a suppressant for suppressing generation of the dust is to be sprayed on a surface of the object.
